(19) United States
(12) Patent Application Publication
(10) Pub. No.: US 2017/0180501 A1
(43) Pub. Date: Jun. 22, 2017

(54) MESSAGE PUSHING METHOD AND MESSAGE PUSHING DEVICE

(71) Applicant: INDUSTRIAL TECHNOLOGY RESEARCH INSTITUTE, Hsinchu (TW)

(72) Inventors: Jian-Ren CHEN, Hsinchu City (TW); Su-Chen HUANG, Taoyuan City (TW); Chun-Yen CHEN, Miaoli County (TW); Szu-Hsien YEH, Chiayi County (TW); Chao-Wang HSIUNG, Taoyuan City (TW)

(73) Assignee: INDUSTRIAL TECHNOLOGY RESEARCH INSTITUTE, Hsinchu (TW)

(21) Appl. No.: 15/348,900

(22) Filed: Nov. 10, 2016

(30) Foreign Application Priority Data
Dec. 21, 2015 (TW) 104143014

(51) Int. Cl. H04L 29/08; G06T 7/40; G06K 9/46; G06T 7/00; G06K 9/00; G06T 11/60

(52) U.S. Cl. CPC H04L 67/26; G06K 9/00624; G06T 11/60; G06K 9/4604; G06T 7/0085; G06T 7/408; G06Q 30/0272

(57) ABSTRACT

A message pushing method and a message pushing device are provided. The message pushing method includes the following steps. Acquire a portrait image from a scene image, and obtain an attribute, representing the portrait image, by extracting features of a body part shown in the portrait image. Select one of a plurality of pushing information according to the attribute of the portrait image. The selected pushing information has a second image. Obtain a first image by performing an image processing procedure to the portrait image, and produce a synthesis image by combining the first image and the second image. Display the synthesis image to an attracted-viewer relating to the portrait image.

### CROSS-REFERENCE TO RELATED APPLICATIONS

The present application is based on, and claims priority from, Taiwan Application Serial Number 104143014, filed on Dec. 21, 2015, the disclosure of which is hereby incorporated by reference herein in its entirety.

### TECHNICAL FIELD

The disclosure relates to a message pushing method and a message pushing device.

### BACKGROUND

It has been well-known that the efficient advertising exposure rate of modern advertising methods is very low in the art. It is because an advertising company needs to spend a long time and a lot of money on studying customer behavior and producing an advertisement.

When an advertisement has been viewed many times, viewers may not be interested in it any longer, and the content of the advertisement may not be relevant to one or more of the viewers. Moreover, the broadcasting of advertising has a given schedule and thus, lacks mobility and flexibility.

### SUMMARY

According to one or more embodiments, the disclosure provides a message pushing method which includes the following steps. Acquire a portrait image from a scene image. Obtain an attribute, which represents the portrait image, by extracting features of a body part shown in the portrait image. Select one of a plurality of pushing information, according to the attribute of the portrait image, from a database stored in a memory device. The selected pushing information has a second image. Obtain a first image by performing an image processing procedure to the portrait image. Produce a synthesis image by combining the first image and the second image. Display the synthesis image to an attracted-viewer relating to the portrait image.

According to one or more embodiments, the disclosure provides a message pushing device which includes an image capturing unit, an attribute analyzing unit, a selecting unit, an image processing unit and an image output unit. The attribute analyzing unit is coupled to the image capturing unit. The selecting unit is coupled to the attribute analyzing unit. The image output unit is coupled to the image processing unit. The image processing unit is coupled to the image capturing unit and the selecting unit. The image capturing unit captures a scene image and acquires a portrait image from the scene image. The attribute analyzing unit extracts features of a body part shown in the portrait image to obtain an attribute of the portrait image. The selecting unit selects one of a plurality of pushing information according to the attribute of the portrait image. The selected pushing information has a second image. The image processing unit performs an image processing procedure to the portrait image to obtain a first image, and combines the first image and the second image to obtain a synthesis image. The image output unit displays the synthesis image.

The foregoing will become better understood from a careful reading of a detailed description provided herein below with appropriate reference to the accompanying drawings.

### BRIEF DESCRIPTION OF THE DRAWINGS

FIG. 1 is a block diagram of a message pushing device according to an embodiment of the disclosure.

FIG. 2 is a schematic diagram of a scene image according to an embodiment of the disclosure.

FIG. 3 is a schematic diagram of a synthesis image concerning to FIG. 2 according to an embodiment of the disclosure.

FIG. 4 is a schematic diagram of a scene image according to another embodiment of the disclosure.

FIG. 5 is a schematic diagram of a synthesis image concerning to FIG. 4 according to an embodiment of the disclosure.

FIG. 6 is a schematic diagram of a scene image according to yet another embodiment of the disclosure.

FIG. 7 is a schematic diagram of a synthesis image concerning to FIG. 6 according to an embodiment of the disclosure.

FIG. 8 is a flow chart of a message pushing method according to an embodiment of the disclosure.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

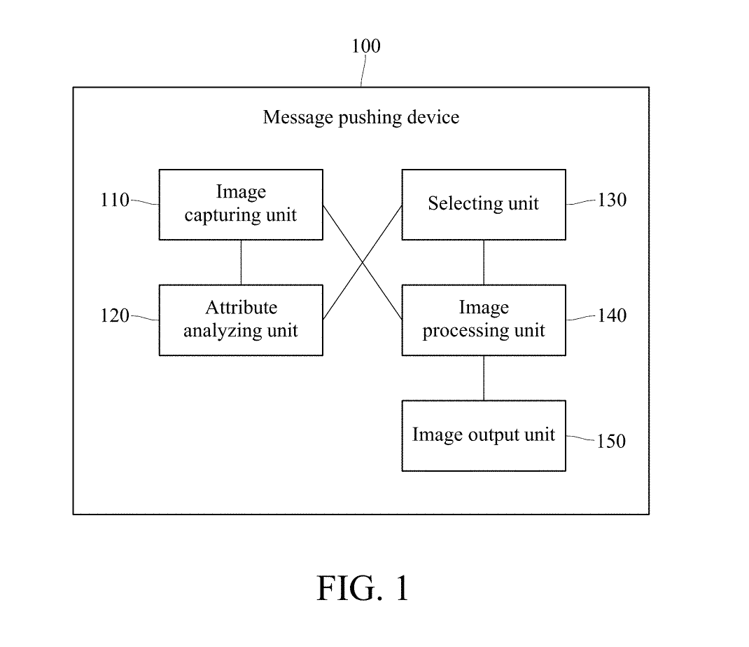

FIG. 1 is a block diagram of a message pushing device 100 according to an embodiment. As shown in FIG. 1, the message pushing device 100 includes an image capturing unit 110, an attribute analyzing unit 120, a selecting unit 130 and an image processing unit 140. The attribute analyzing unit 120 is coupled to the image capturing unit 110; the selecting unit 130 is coupled to the attribute analyzing unit 120; the image processing unit 140 is coupled to the image capturing unit 110 and the selecting unit 130; and the image output unit 150 is coupled to the image processing unit 140. In the embodiment, “couple to” may be implemented in wire or wireless manner.

In this embodiment, the message pushing device 100 may be, for example, but not limited to, a portable mobile device, a personal computer or another type of electronic device. The image capturing unit 110, the attribute analyzing unit 120, the selecting unit 130 and the image processing unit 140 respectively or integrally may be embodied by varieties of circuits, chips or microprocessors, and the disclosure is not restricted to this embodiment. The image output unit 150 may be a variety of display devices, such as displaying TV, electronic shopping window, etc. Embodiments of the disclosure may be implemented via the microprocessor and/or memory device. For example, the functionalities described in the followings may be implemented via hardware logic in the microprocessor or be executed instructions stored in the memory device. Thus, the disclosure is not limited to a specific configuration of hardware and/or software.

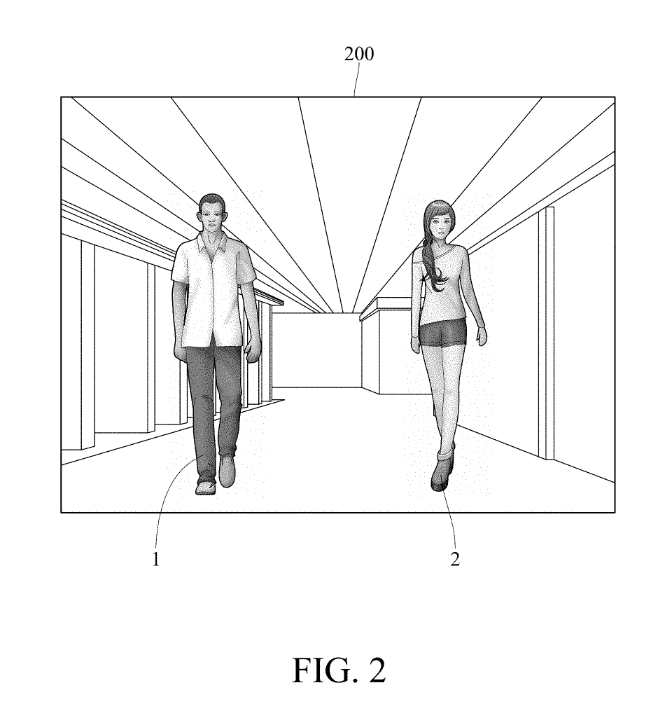

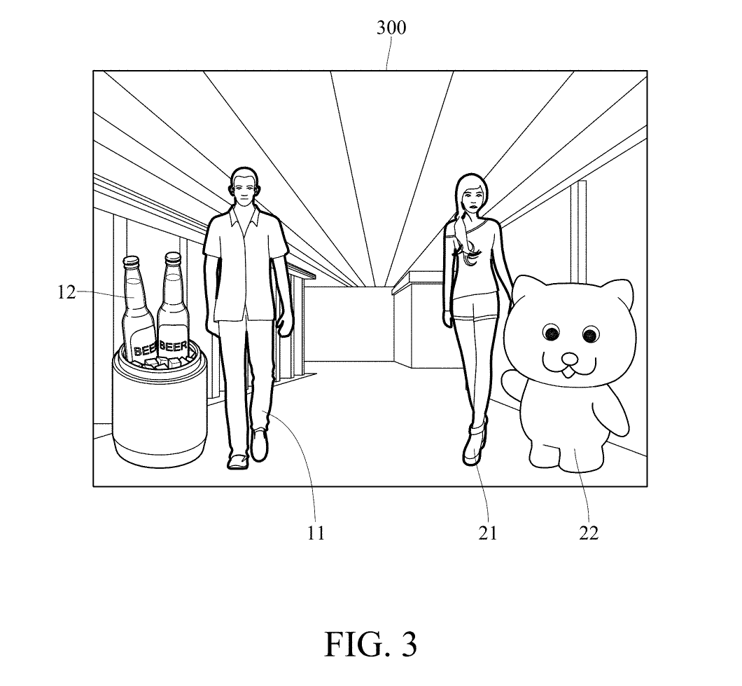

FIG. 2 is a schematic diagram of a scene image 200 according to an embodiment, and FIG. 3 is a schematic diagram of a synthesis image 300 concerning to FIG. 2 according to an embodiment.

As shown in FIG. 2, the message pushing device 100 may be located at a corner of a market, and the image capturing unit 110 may capture an image of at least a part of the market to obtain the scene image 200 and acquire or extract the portrait images 1 and 2 from the scene image 200. The portrait images 1 and 2 may be two images of two real humans, for example. In an embodiment, the image capturing unit 110 may be a video camera setup in a shopping mall, but the disclosure is not limited thereto.

The attribute analyzing unit 120 may be configured to extract features of a body part from the portrait image 1 to obtain the attribute representing the portrait image 1 and to extract features of the body part from the portrait image 2 to obtain the attribute representing the portrait image 2. In this embodiment, the attribute herein may include, but not limit to, an age attribute and/or a gender attribute. The extracted features of a body part herein may be features of the head of a human shown in the portrait image. For example, the extracted features of the head may be, but not limited to, the amount of wrinkles on the face, the skin status, the hair color, the hair distribution on the head, or the rate at which a portion of the face droops, and the disclosure is not restricted to these examples. For instance, if in view of the extracted features, the attribute analyzing unit 120 estimates that the human shown in the portrait image 1 has the maximum possibility of a 52-year-old man, the attribute analyzing unit 120 will set the gender attribute of the portrait image 1 to be male and will set the age attribute of the portrait image 1 to be 52 years old. Likewise, if the attribute analyzing unit 120 estimates that the human shown in the portrait image 2 has the maximum possibility of a 30-year-old woman, the attribute analyzing unit 120 will set the gender attribute of the portrait image 2 to be female and the age attribute of the portrait image 2 to be 30 years old.

The selecting unit 130 may be configured to select one of a plurality of pushing information according to the attribute of the portrait image. In this embodiment, each pushing information may be related to an applicable age probability distribution, an applicable gender probability distribution and a pushing status. The pushing status may include an available pushing quantity M and a quantity of accomplished pushes N, wherein M may be greater than or equal to N. The available pushing quantity M may be a maximum quantity of available pushing quantity, but the disclosure is not limited thereto. In the embodiment, the selected pushing information may be, but not limited to, selected by the selecting unit 130 from a database, wherein the database may include a plurality of pushing information therein. The database may be stored in a memory device.

In this embodiment, the selecting unit 130 may further determine a first output probability for each of the plurality of pushing information according to the age attribute and the related applicable age probability distribution, determine a second output probability for each of the plurality of pushing information according to the gender attribute and the related applicable gender probability distribution, and determine a third output probability for each of the plurality of pushing information according to the related pushing status. Then, the selecting unit 130 may select one of the pluralities of pushing information according to the first output probabilities, the second output probabilities and the third output probabilities.

For example, the selecting unit 130 may select the suitable one from the plurality of pushing information corresponding to the portrait image 1 or the portrait image 2. To determine which one of pushing information is the suitable one, the selecting unit 130 may do a lookup in a table according to the gender attribute (i.e. male) and the age attribute (52 years old) of the portrait image 1, wherein the table may include information of one or more main attribute groups (gender, age) corresponding to the plurality of pushing information.

The applicable age probability distribution may be recorded in a first probability table, for example, and the first probability table may present a normal distribution of each age to the pushing probability of pushing information. The applicable gender probability distribution may be recorded in a second probability table, for example, and the second probability table may present a normal distribution of two genders to the pushing probability of pushing information. Furthermore, a third probability table related to the pushing statuses may present the pushing probabilities of a variety of ratios between the quantity of accomplished pushes N and the available pushing quantity M.

For example, the pushing information of either a product of Sliver Medal Beer or a product of Lovely Bear may be promoted to a viewer in accordance with the portrait image 1. In this example, if the age attribute is concerned in the above analysis, the first output probability, found in the first probability table related to the pushing information of the product of Sliver Medal Beer according to the 52-year-old attribute, may be higher than the first output probability, found in the first probability table related to the pushing information of the product of Lovely Bear according to the 52-year-old attribute. In other words, the 52-year-old viewer is more suitable to receive the pushing information of the product of Sliver Medal Beer.

If a gender attribute is concerned in the above analysis, the second output probability, which is found in the second probability table of the pushing information of the product of Sliver Medal Beer according to the male attribute, may be higher than the second output probability, which is found in the second probability table of the pushing information of the product of Lovely Bear according to the male attribute. In other words, the male viewer may be more suitable to receive the pushing information of the products of Sliver Medal Beer. Likewise, if the age attribute and gender attribute of the portrait image 2 are concerned in the above analysis, it may be estimated that the 30-year-old female viewer shown in the portrait image 2 is more suitable to receive the pushing information of the product of Lovely Bear, and this analysis process may be deduced by the analysis process done to the portrait image 1, and thus, will not be repeated hereinafter.

In addition, for example, if an available pushing quantity M for the pushing information of the product of Sliver Medal Beer in the third probability table is a total of 1000, the third output probability, which the pushing information of the product of Sliver Medal Beer has been pushed 950 times, may be lower than the third output probability, which the pushing information of the product of Sliver Medal Beer has been pushed 500 times. However, the disclosure is not restricted to this example. In another example, the higher the quantity of accomplished pushes N is, the higher the third output probability is.

Therefore, the selecting unit 130 looks up the first, second and third output probabilities of the pushing information of the product of Sliver Medal Beer and the first, second and third output probabilities of the pushing information of the product of Lovely Bear according to the attributes of the portrait image 1, so as to set these output probabilities as a basis for selecting either the pushing information of the product of Sliver Medal Beer or the pushing information of the product of Lovely Bear. Then, the pushing information of the product of Sliver Medal Beer is selected and pushed to a viewer in accordance with the portrait image 1. Similarly, the selecting unit 130 selects the pushing information of the product of Lovely Bear and pushes it to a viewer in accordance with the portrait image 2 according to the look-up result based on the attributes of the portrait image 2.

In this embodiment, the selected pushing information may include a second image, and the second image may be a promotional product image representing a product. For example, the product image related to the pushing information of the product of Sliver Medal Beer may be a graphic bottle pattern of Sliver Medal Beer, as shown in the second image 12 in FIG. 3. For example, the product image related to the pushing information of the product of Lovely Bear may be a toy figure pattern of Lovely Bear, as shown in the second image 22 in FIG. 3.

The image processing unit 140 may be configured to perform an image processing procedure to the portrait image to obtain a first image, and may be also configured to combine the first image and the second image to a synthesis image. In this embodiment, the image processing procedure herein includes an edge processing procedure, a color processing procedure and a texture processing procedure.

For example, to attract a viewer, the image processing unit 140 performs an image processing procedure to the above portrait image, so the processed portrait image may have a specific style, e.g. anime comic style. To obtain a processed portrait image having a anime comic style, the above edge processing procedure may be performed to remove relevant noises from the edge of the primary portrait image, or to make the edge of the portrait image become a boldfaced line, or to streamline the edge of the portrait image, or other edge processing methods, and the disclosure is not restricted to this example. Alternatively, the above color processing procedure may be performed to digitize the colors of a primary portrait image which uses the colors are, for example, black and white, or may be performed to simplify the tints of a primary portrait image, or may be other color processing methods capable of making the colors of a primary portrait image more attractive. Alternatively, the above texture processing procedure may be performed to vary the texture of the local region of a primary portrait image, e.g. to transform the local region to a region having a hand-drawn texture.

For example, the above image processing procedure may be performed to the portrait image 1 to obtain the first image 11 in an anime comic style, and the above image processing procedure may be also performed to the portrait image 2 to obtain the first image 21 in an anime comic style, as shown in FIG. 3. Then, the image processing unit 140 may combine the first images 11 and 21 and the second images 12 and 22 to a synthesis image 300. The image output unit 150 may be configured to output the synthesis image 300, as shown in FIG. 3. In another embodiment, the second image may be located near the face in the related first image in the synthesis image, so the viewer may more easily become aware of the related promotional message.

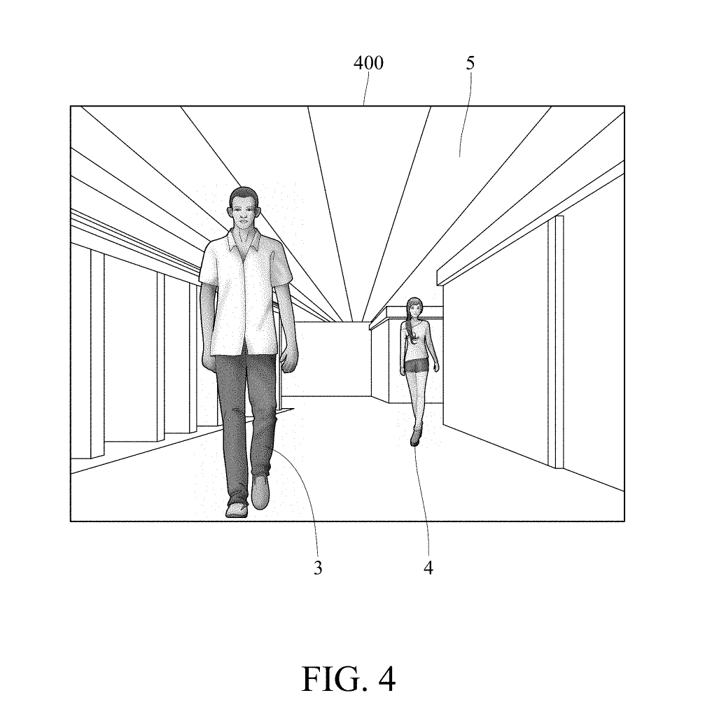

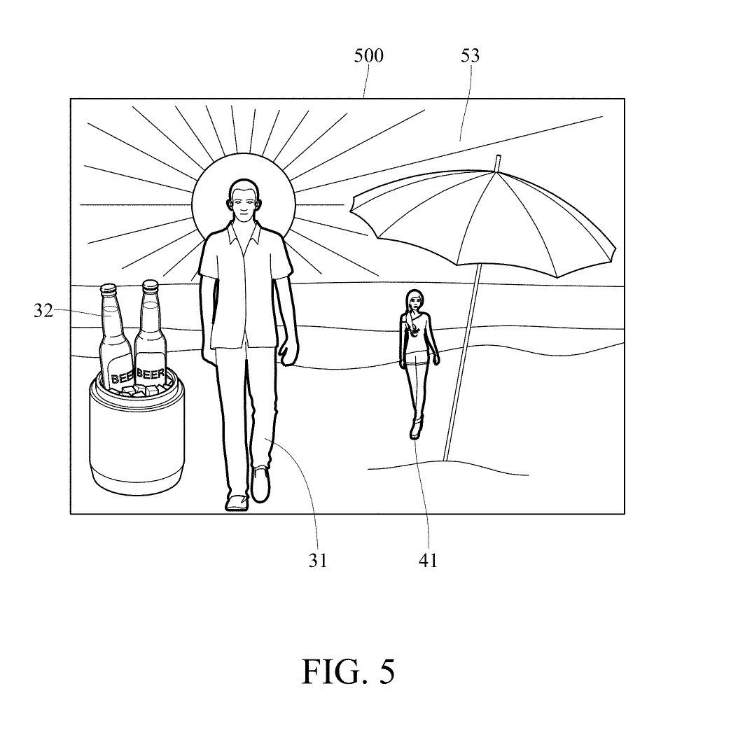

FIG. 4 is a schematic diagram of a scene image 400 according to another embodiment. FIG. 5 is a schematic diagram of a synthesis image 500 concerning to FIG. 4 according to an embodiment. As shown in FIG. 4, the message pushing device 100 may be disposed at a certain corner of a market, and the image capturing unit 110 is employed to capture an image of at least a part of the market to obtain the scene image 400 and acquire the portrait images 3 and 4 in the scene image 400.

In this embodiment, when the attribute analyzing unit 120 may determine that the amount of portrait images is more than one, the attribute analyzing unit 120 may select one of the portrait images according to their attributes, and may set the selected portrait image as a spot portrait image for pushing a message. The above attributes may further include the attention information, the distance information and the distance variance. The distance information herein may be related to a physical distance between the message pushing device 100 (e.g. the center of the lens of the image capturing unit 110) and a human, wherein a portrait image of the human is captured by the image capturing unit 110. The distance variance herein may be related to a quantity of the movement of the human. For example, when the acquired distance information changes from small to large, it indicates that the human is relatively close to the message pushing device 100, thus, a possibility of setting the related portrait image as a spot portrait image for a message to be pushed may increase. When the acquired distance information changes from large to small, it indicates that the related human is moving away from the message pushing device 100, thus, a possibility of setting the related portrait image as a spot portrait image for a message to be pushed may decrease. If there is more than one portrait image each showing a human, the possibilities of setting them as the spot portrait image are arranged according to the distance information of these portrait images.

The above attention information may be related to an offset angle of the face shown in the portrait image, the gazing direction, or the gazed region. The distance information may be related to a size of the related portrait image. For example, the attribute analyzing unit 120 may analyze the portrait images 3 and 4 to know that the offset angles of the faces in the portrait images 3 and 4 in relation to the image output unit 150 are less than 15 degrees, and the viewer related to the portrait image 3 is relatively close to the image output unit 150 as compared to the viewer related to the portrait image 4 (i.e. the size of the portrait image 3 is larger than the size of the portrait image 4). Therefore, the attribute analyzing unit 120 considers that pushing a message to the human shown in the portrait image 3 may have a relatively great benefit, so that the attribute analyzing unit 120 may set the portrait image 3 as a spot portrait image for pushing a message.

After the spot portrait image is selected, the selecting unit 130 may select one of the plurality of pushing information according to the attribute of only the portrait image 3. In other words, the selecting unit 130 may not select any pushing information for the portrait image 4.

Accordingly, as described above, the selecting unit 130 may survey in the probability table related to the pushing information of the products of Sliver Medal Beer and Lovely Bear according to the attribute of the portrait image 3, so as to determine to push the second image 32 corresponding to the pushing information of the product of Sliver Medal Beer to the human shown in the portrait image 3 rather than the portrait image 4. As described above, the image processing unit 140 may also perform the above image processing procedure to the portrait images 3 and 4 to obtain the first images 31 and 41 in an anime comic style. In another embodiment, because the message may not be pushed to the human shown in the portrait image 4, the above image processing procedure may not be performed to the portrait image 4 to obtain a first image 41.

Moreover, in this embodiment, the image capturing unit 110 may further acquire the background image 5 in the scene image 400, and the selected pushing information of the product of Sliver Medal Beer may further include the pushing situation information. In this embodiment, the image processing unit 140 may further transform the background image to a third image according to the pushing situation information. For example, the originally-acquired background image 5 is related to the market and the selecting unit 130 selects the pushing information of the product of Sliver Medal Beer in response to the portrait image 3, so the image processing unit 140 may transform the background image 5 to the third image 53 having a beach circumstance according to the pushing situation information.

Finally, the image processing unit 140 may combine the first images 31 and 41, the second image 32 and the third image 53 to a synthesis image 500 and send the synthesis image 500 to the image output unit 150, and the image output unit 150 may output this synthesis image 500, as shown in FIG. 5. In another embodiment, the second image may be located near the human face in the first image in view of the synthesis image, so the viewer may become aware of the relevant pushing information.

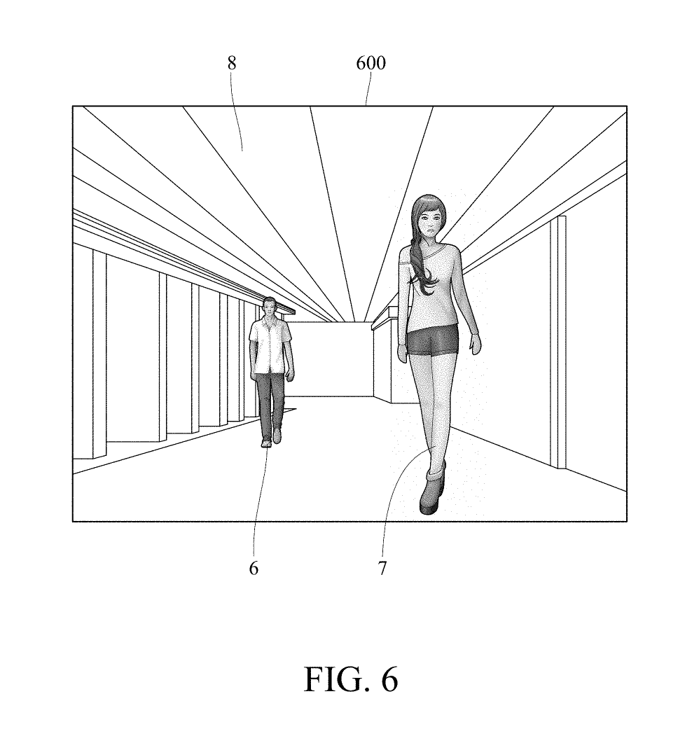

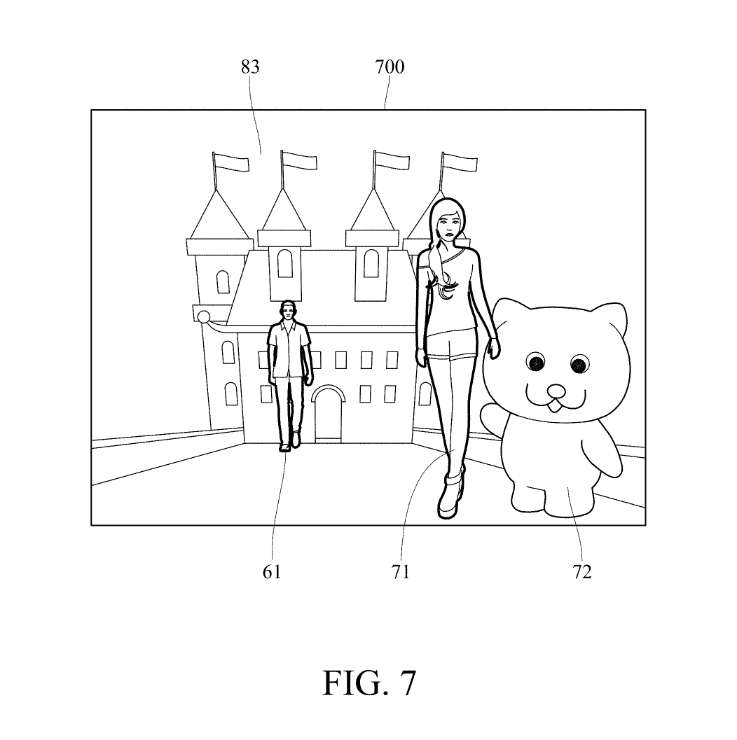

FIG. 6 is a schematic diagram of a scene image 600 according to yet another embodiment. FIG. 7 is a schematic diagram of a synthesis image 700 concerning to FIG. 6 according to an embodiment. As shown in FIG. 6, the message pushing device 100 may be disposed at a certain corner of a market, and the image capturing unit 110 may acquire the portrait images 6 and 7 in the scene image 600 after capturing an image of at least a part of the market to obtain the scene image 600.

As aforementioned, when the attribute analyzing unit 120 determines that the amount of portrait images is more than one, the attribute analyzing unit 120 may select one of the portrait images according to the attributes and set the selected portrait image as a spot portrait image for pushing a message. For instance, the attribute analyzing unit 120 may determine that the distance between the image output unit 150 and the viewer related to the portrait image 7 is shorter than a threshold, and that the distance between the image output unit 150 and the viewer related to the portrait image 6 is longer than the threshold. In this instance, the attribute analyzing unit 120 may consider that pushing a message to a viewer related to the portrait image 7 may have a relatively great benefit, so the attribute analyzing unit 120 sets the portrait image 7 as a spot portrait image for pushing the message.

After the spot portrait image is defined, the selecting unit 130 may select one of the plurality of pushing information according to the attribute of the portrait image 7. In other words, the selecting unit 130 may not select any pushing information for the portrait image 6.

Therefore, as described above, the selecting unit 130 may look up in the probability table related to the pushing information of the products of Sliver Medal Beer Lovely Bear according to one or more attributes of the portrait image 7, so as to determine to push the second image 72 related to the pushing information of the product of Lovely Bear to a viewer in the portrait image 7 rather than the portrait image 6. As described above, the image processing unit 140 may also perform the above image processing procedure to the portrait images 6 and 7 to obtain the first images 61 and 71 in an anime comic style, respectively. In another embodiment, since no message may be pushed for the portrait image 6, the above image processing procedure may not be performed to the portrait image 6 to obtain the first image 61.

In another embodiment, the selecting unit 130 may push more than one promotional message at the same time. For instance, more than one promotional message is pushed for the same portrait image at the same time. Moreover, the selecting unit 130 may have an upper limitation of the amount of multiple promotional messages to be pushed. The upper limitation of the amount of multiple promotional messages to be pushed may be defined according to the age attribute, gender attribute, attention information, distance information and distance variance of the above portrait image, the pushing status, the first output probability related to the age attribute, the second output probability related to the gender attribute, and the third output probability related to the pushing status.

Moreover, in this embodiment, the image capturing unit 110 may acquire the background image 8 in the scene image 600, and the selected pushing information of the product of Sliver Medal Beer may further include the pushing situation information. In this embodiment, the image processing unit 140 may transform the background image to the third image according to the pushing situation information. For example, the acquired background image 8 may be related to the market, and because the selecting unit 130 may select the pushing information of the product of Lovely Bear for the portrait image 7, the image processing unit 140 may transform the background image 5 to the third image 83 having a romantic castle circumstance according to the pushing situation information.

Finally, the image processing unit 140 may combine the first images 61 and 71, the second image 72 and the third image 83 to a synthesis image 700 and send the synthesis image 700 to the image output unit 150, so the image output unit 150 may output the synthesis image 700, as shown in FIG. 7. In another embodiment, the second image may be located near the face in the related first image in the synthesis image, so the viewer may be more easily aware of the related pushed message.

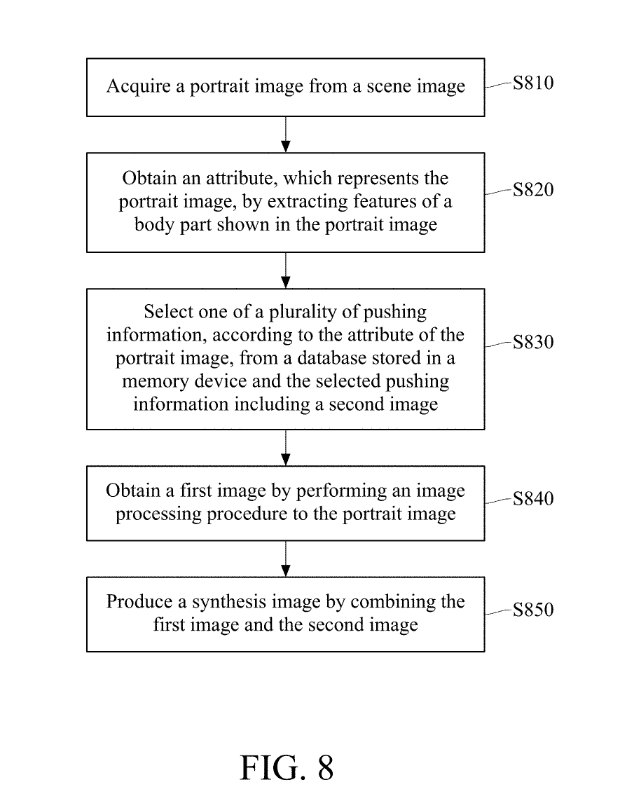

FIG. 8 is a flow chart of a message pushing method according to an embodiment. As shown in FIG. 8, the message pushing method includes steps S810-S850. In step S810, the image capturing unit 110 may acquire a portrait image in a scene image. In step S820, the attribute analyzing unit 120 may analyze a local feature of the portrait image to obtain an attribute of the portrait image. In step S830, the selecting unit 130 may select one of a plurality of pushing information according to one or more attributes. The selected pushing information may have a second image. In step S840, the image processing unit 140 may perform an image processing procedure to the portrait image to obtain a first image. In step S850, the image processing unit 140 may combine the first and second images to a synthesis image.

It will be apparent to those skilled in the art that various modifications and variations may be made to the disclosed embodiments. It is intended that the specification and examples be considered as exemplary only, with a true scope of the disclosure being indicated by the following claims and their equivalents . . . .

1. A message pushing method, comprising:
acquiring a portrait image from a scene image;
obtaining an attribute, representing the portrait image, by extracting features of a body part shown in the portrait image;
selecting one of a plurality of pushing information, according to the attribute of the portrait image, from a database stored in a memory device and the selected pushing information including a second image;
obtaining a first image by performing an image processing procedure to the portrait image;
producing a synthesis image by combining the first image and the second image; and
displaying the synthesis image to an attracted-viewer relating to the portrait image.

2. The message pushing method of claim 1, wherein the attribute of the portrait image includes an age attribute, a gender attribute, attention information, distance information and a distance variance, and the distance information and the distance variance are related to the portrait image of the attracted-viewer.

3. The message pushing method of claim 2, wherein each of the plurality of pushing information is related to one of a plurality of applicable age probability distributions, one of a plurality of applicable gender probability distributions and one of a plurality of pushing statuses, and each of the plurality of pushing statuses includes an available pushing quantity and a quantity of accomplished pushes.

4. The message pushing method of claim 3, wherein selecting one of the plurality of pushing information according to the attribute of the portrait image includes:
determining a first output probability for each of the plurality of pushing information according to the age attribute and the applicable age probability distribution of each of the plurality of pushing information;
determining a second output probability for each of the plurality of pushing information according to the gender attribute and the applicable gender probability distribution of each of the plurality of pushing information;
determining a third output probability for each of the plurality of pushing information according to the pushing status of each of the plurality of pushing information; and
selecting one of the plurality of pushing information according to the first output probabilities, the second output probabilities and the third output probabilities.

5. The message pushing method of claim 1, wherein the second image is a promotional product image.

6. The message pushing method of claim 1, wherein the method further includes:
acquiring a background image of the scene image.

7. The message pushing method of claim 6, wherein the selected pushing information further includes pushing situation information, and the step of producing a synthesis image includes:
transforming the background image to a third image according to the pushing situation information; and
combining the first image, the second image and the third image to the synthesis image.

8. The message pushing method of claim 1, wherein the image processing procedure includes an edge processing procedure, a color processing procedure and a texture processing procedure.

9. A message pushing device, comprising:
an image capturing unit configured to capture a scene image and acquire a portrait image from the scene image;
an attribute analyzing unit coupled to the image capturing unit and configured to extract features of a body part shown in the portrait image to obtain an attribute of the portrait image;
a selecting unit coupled to the attribute analyzing unit and configured to select one of a plurality of pushing information according to the attribute of the portrait image, and the selected pushing information having a second image;
an image processing unit coupled to the image capturing unit and the selecting unit and configured to perform an image processing procedure to the portrait image to obtain a first image, and combine the first image and the second image to obtain a synthesis image; and
an image output unit coupled to the image processing unit and configured to display the synthesis image.

10. The message pushing device of claim 9, wherein the attribute of the portrait image includes an age attribute, a gender attribute, attention information, distance information and a distance variance, and the distance information and the distance variance are related to a human shown in the portrait image.

11. The message pushing device of claim 10, wherein each of the plurality of pushing information is related to one of a plurality of applicable age probability distributions, one of a plurality of applicable gender probability distributions and one of a plurality of pushing statuses, and each of the plurality of pushing statuses includes a maximum quantity of available pushes and a quantity of accomplished pushes.

12. The message pushing device of claim 11, wherein the selecting unit determines a first output probability for each of the plurality of pushing information according to the age attribute and the applicable age probability distribution of each of the plurality of pushing information; the selecting unit determines a second output probability for each of the plurality of pushing information according to the gender attribute and the applicable gender probability distribution of each of the plurality of pushing information; the selecting unit determines a third output probability for each of the plurality of pushing information according to the pushing status of each of the plurality of pushing information; and the selecting unit selects one of the plurality of pushing information according to the first output probabilities, the second output probabilities and the third output probabilities.

13. The message pushing device of claim 12, wherein the second image is a product image.

14. The message pushing device of claim 13, wherein the image capturing unit further acquires a background image from the scene image.

15. The message pushing device of claim 14, wherein the selected pushing information further includes pushing situation information, and the image processing unit transforms the background image to a third image according to the pushing situation information and combines the first image, the second image and the third image to obtain the synthesis image.

16. The message pushing device of claim 15, wherein the image processing procedure includes an edge processing procedure, a color processing procedure and a texture processing procedure.
